(19) United States
(12) Patent Application Publication
(10) Pub. No.: US 2006/0204741 A1
(43) Pub. Date: Sep. 14, 2006

(54) Contact surfaces for electrical contacts and method for producing the same

(76) Inventors: Peter Rehbein, Weissach (DE); Volker Haas, Tamm (DE)

Correspondence Address: BAKER & DANIELS LLP;111 E. WAYNE STREET, SUITE 800, FORT WAYNE, IN, 46802, US

(21) Appl. No.: 10/544,718

(22) PCT Filed: May 21, 2004
(86) PCT No.: PCT/EP04/50881

§ 371 Date: Aug. 4, 2005

(30) Foreign Application Priority Data
Jun. 13, 2003 (DE) 103 26 788.3

(51) Int. Cl. B32B 3/26; B05D 5/12; B05D 3/02

(52) U.S. Cl. 428/304.4; 428/613; 427/58; 427/372.2

(57) ABSTRACT

A method of making contact surfaces for electrical contacts in which a metal is deposited on a copper-based substrate by a galvanic process. The metal is deposited on the substrate along with a placeholder material that can easily be dissolved out of the metal. The placeholder material is then dissolved out of the metal layer, and the remaining porous metal foam is impregnated with a lubricant.

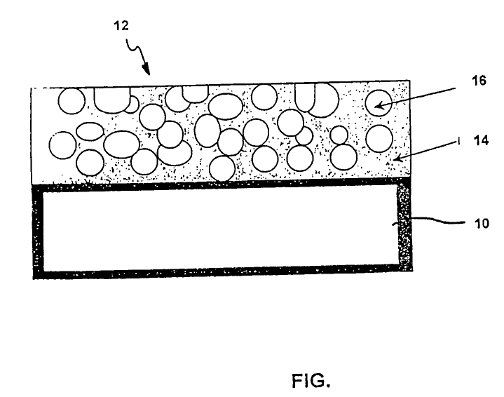

The invention concerns improved contact surfaces for electrical contacts and a method of making same according to the preambles of the independent claims.

### PRIOR ART

Electrical plug-type connectors comprising sockets, contacts and blades (pins) typically include substrates made from a copper-based alloy that provides good electrical conductivity. If the electrical connector is exposed to elevated temperatures during operation, such as under the hood of a motor vehicle, for example, the copper-based alloy substrate is made to have high strength and a high stress relaxation resistance.

To reduce insertion forces, wear and oxidation, to safeguard electrical functioning, to reduce tarnishing of the copper-based substrate at elevated temperature and to improve solderability, a cover layer is frequently applied to the substrate. Typical cover layers are composed of silver, gold, nickel, palladium/nickel alloys, tin or tin alloys. To minimize costs, tin is often used, usually in the form of hot-dip tinned or galvanically deposited layers a few microns thick. Tin excels in these applications by virtue of its ductility and good electrical conductivity. Disadvantages of these tin cover layers are high susceptibility to fretting corrosion, plastic deformation, a tendency toward adhesion, and low wear resistance.

The substrate is usually made of copper-based alloys such as, for example, CuSn bronze, CuNiSi, etc., which often serve as the base material for electrical plug-type connections. At elevated temperatures, copper may come to diffuse out of the substrate and combine with the tin to form intermetallic compounds such as Cu₆Sn₅ and Cu₃Sn. The formation of these intermallic compounds reduces the quantity of unreacted or free tin at the surface. This degrades the electrical, corrosion and other performance properties.

A “tin layer” produced by thermal aging and composed entirely of intermetallic phases is known as thermic tin. AuCo alloys with nickel underplating are also frequently used, as are Ag surfaces, with copper or nickel underplating in some cases.

However, thermic tin has not yet proven to be a successful solution under all test conditions (e.g. chemical testing or abrasive loading) and consequently has a negligibly small market share.

It is further known that the very low hardness and wear resistance of tin alloys makes them readily susceptible to increased oxidation (fretting corrosion) and rub-through due to frequent insertion or vehicle- or engine-induced vibrations. Such rub-through and fretting corrosion can lead to failure of a component (sensor, control unit, electrical components in general).

In addition, owing to the strong tendency toward adhesion and the plastic deformation, the insertion forces are too high for many applications. Special surfaces based on tin and silver tend to cold-weld due to adhesion and are characterized by high friction values (friction coefficient μ≈1) in self-pairings.

Conventional silver or gold layers can also be subject to layer rub-through or layer spalling due to poor adhesion to oxidative wear processes of the base material or the intermediate layer (often Cu or Ni).

The use of leaded tin layers is prohibited by EC End-of-Life Vehicles Directive 2000/53. Since lead prevents whisker formation (whiskers are tiny, hair-shaped crystals) in galvanic surface coatings, galvanic pure tin is more subject to whisker growth, which can cause short circuits.

U.S. Pat. No. 5,916,695 discloses an electrical contact with a copper-based substrate that is provided with a tin-based cover layer. To prevent the diffusion of copper from the substrate into the cover layer and the associated formation of intermetallic layers, a barrier layer is applied between the substrate and the cover layer. This barrier layer contains 20 to 40% wt. % nickel and is preferably composed primarily of copper (Cu-based). The tin-based cover layer can contain additives as lubricants, such as, inter alia, SiO₂, Al₂O₃, SiC, graphite or MoS₂.

### ADVANTAGES OF THE INVENTION

The inventive contact surfaces possess the advantage over the prior art of requiring lower insertion forces while preserving good contacting.

It is further advantageous that owing to the antioxidant content of the lubricant they contain, they protect the surface against corrosion.

A further advantage is that the lubricant is available throughout the life of the contact and can be released during tribological processes.

Advantageous improvements of the invention will emerge from the measures cited in the dependent claims.

For example, it is advantageous if a diffusion barrier layer is deposited on the substrate.

### BRIEF DESCRIPTION OF THE DRAWING

Exemplary embodiments of the invention are depicted in the drawing and described in greater detail in the description that follows. The sole FIGURE schematically illustrates the structure of the inventive contact surface.

### EXEMPLARY EMBODIMENTS

The core of the invention is the structure of a cover layer on a copper-based substrate for electrical contacts that makes it possible to require lower insertion forces, while preserving good contacting, and to achieve good wear resistance throughout the life of the electrical contact.

As shown in the FIGURE, a contact surface 12 is first produced on the electrical contact, i.e., on the copper-based substrate 10, by a galvanic process, e.g. high-speed deposition in belt systems. To this end, a metal, for example tin, silver or copper, is deposited, along with an additional material (hereinafter referred to as a “placeholder material”) that can easily be dissolved back out of the metal at a subsequent time, until the desired layer thickness is attained. Depending on the application concerned, economic considerations, and the process selected, the layer thickness is generally between about 0.5 and about 10 μm. The placeholder material can be polystyrene beads, for example.

However, latex spheres or other synthetic materials that can be thermally decomposed or dissipated satisfactorily can also be contemplated. Polyethylene, non-noble metals, sulfur, phosphorus, sulfur compounds, phosphorus compounds, sisal, cornstarch and the like can also be used.

The dissolving out of the material can be effected by thermal and/or solvent treatment, such as, for example, the dissolution of polystyrene beads in toluene. Thermal treatment is an option with materials that readily decompose and pass into the gas phase; treatment with solvents, for example toluene, acetone, gasoline for cleaning purposes, alcohols and the like, is preferred when a hard-to-remove melt forms under thermal stress, for example, or when it is easier in terms of process engineering, faster, or less expensive to perform. What remains after the dissolving out is a highly porous skeleton formed by the metal, the so-called metal foam 14. The pores form over the entire layer. Care should be taken to ensure that the percentage of pores is in the range of approximately 20 to approximately 50%, since otherwise the lubricant is not sure to percolate. If problems should arise with regard to mechanical stability, the pore ratio should be adjusted so that the layer is mechanically stable as well.

In a second step, this metal foam is impregnated with a lubricant. The lubricant can be chosen from solid lubricants such as, for example, graphite, MoS₂ and the like, or liquid lubricants such as oils, for example, or fats dissolved in solvents.

Due to the very strong capillary action caused by the small pores 16 (average pore size in the range of 0.1 to 5 μm) of the metal foam 14, the lubricant is sucked into the pores 16 and held there. It is also possible to dissolve a solid lubricant in a solvent and then let it soak in. The metal foam thereby constitutes a retention volume for the lubricant. The lubricant thus cannot be driven out of the wear region and remains available throughout the life of the contact.

The deposited metal can be, for example, copper and Cu alloys, for example containing Be or like metals; Sn and Sn alloys, particularly Sn/Ag, Ag and Ag alloys; and Au and Au alloys. These metals can be deposited with or without diffusion barriers such as nickel underplating and with or without a flash composed of a noble metal such as, for example, Au, Pt, Ru or Pd, these preferably being deposited on the Cu alloys.

The layer thickness of the deposited layer is generally between about 0.5 and 10 μm, depending on the application.

Given an average pore size of about 0.1 to 5 μm, the pore geometry can be either round or polyhedral. The average pore size depends on the size distribution of the placeholder material used and the layer thickness, it being a given that pore size≦layer thickness. Whether the pore geometry is round or polyhedral depends on the morphology of the placeholder material used. The pore ratio is between 1 and 80 vol. % of the layer formed.

The inventive contact surfaces permit lower insertion forces due to the lubricant that is present, which is preferably oil or fat, but can also be a solid lubricant in the form of graphite, MoS₂ or the like. Due to the electrical conductivity of the (solid) lubricant, good contacting is assured. Antioxidants contained in the lubricant protect the surface against corrosion; high wear resistance and a high number of insertion cycles are obtained. One major advantage of the inventive contact surfaces derives from the fact that the porous metal foam provides a retention volume for the lubricant. Hence, the lubricant cannot be driven out of the wear boss and therefore remains available throughout the life of the contact.

As an example of the inventive method, 10 g/l of polystyrene beads approximately 1 μm in diameter are deposited galvanically along with Ag. The polystyrene beads are thereby incorporated into the Ag layer. The beads are then dissolved out again by means of toluene.

1. (canceled)

2. The method as described in claim 15 wherein said metal is selected from the group consisting of Cu, Cu alloys, Sn, Sn alloys, Ag, Ag alloys, and Au and Au alloys.

3. The method of claim 15 wherein a diffusion barrier layer is deposited on said substrate prior to said galvanic deposition step.

4. The method of claim 15 wherein said metal is a Cu alloy and further including the step of depositing a flash of noble metal on said Cu alloy.

5. The method of claim 15 wherein said placeholder material is a material selected from the group consisting of synthetic beads, polyethylene, non-noble metals, sulfur, phosphorus, sulfur compounds, phosphorus compounds, sisal, and cornstarch.

6. The method of claim 15 wherein said placeholder material consists of polystyrene beads or latex beads.

7. The method of claim 15 wherein said layer has a thickness in the range of 0.5 to 10 μm.

8. The method of claim 15 wherein the average size of said pores is in the range of 0.1 to 5 μm.

9. The method of claim 15 wherein the ratio of said pores to metal of said metal foam is in the range of 1 to 25% by volume.

10. The method of claim 15 wherein said lubricant is selected from the group consisting of graphite, MoS₂, polytetrafluoroethylene, oils and fats.

11. The method of claim 15 wherein said dissolving step is effected by one of thermal and solvent treatment.

12. A composite material comprising a copper-based substrate and a porous metal layer disposed thereon.

13. The composite material of claim 12 wherein the pores in said porous layer contain a lubricant.

14. (canceled)

15. A method of making a contact surface for an electrical contact, said method comprising:
providing a copper-based substrate;
galvanically depositing a layer composed of a metal and a placeholder material on said substrate;
dissolving said placeholder material from said layer to form pores in said layer to thereby generate a porous metal foam layer; and
impregnating said porous metal foam layer with a lubricant whereby said lubricant fills said pores.
